(19) United States
(12) Patent Application Publication
(10) Pub. No.: US 2012/0303448 A1
(43) Pub. Date: Nov. 29, 2012

(54) METHOD AND APPARATUS FOR DETERMINING AND ALERTING AVAILABILITY OF PREFERRED AUTOMATED TELLER MACHINES

(75) Inventors: Benjamin Psillas, Bethesda, MD (US); Jurie Malan, Frisco, TX (US); Benjamin Bregman, Rockville, MD (US)

(73) Assignee: Cardtronics, Inc., Houston, TX (US)

(21) Appl. No.: 13/116,162

(22) Filed: May 26, 2011

(51) Int. Cl. G06Q 30/00; G06Q 40/00

(52) U.S. Cl. 705/14.49; 705/43

(57) ABSTRACT

An alert process and apparatus employs a geo-coding database to find geographic coordinates corresponding to a street address of a fee-based ATM terminal for which one or more transaction fees or charged to a cardholder to use, employs a terminal locations data store to obtain a street address of an ATM terminal for which no fees or relatively lower fees, would be charged to the cardholder to use, having geographic coordinates closely matching those of the fee-based ATM terminal, and generates alert information including the street address of the non fee-based terminal. Cardholders can be alerted with locations of other ATM's that could have been used for lesser fees or for free, and that are in the vicinity of the ATM that originated the transaction subject to fees. The alert can also present the cardholder with additional benefits or incentives such as discount coupons and/or fee reimbursements.

### BACKGROUND

Most financial institutions now offer many types of banking and financial services to their account holders through automated teller machine terminals (ATMs). To enable use of these services, the financial institution or an entity managing the service on its behalf will issue to the account holder a card. Types of cards include ATM, credit, debit, and prepaid cards. The cards enable the cardholder to conduct certain kinds of transactions through an ATM, such as making withdrawals in the form of cash, transferring money between accounts, making balance inquiries and, depending on the ATM, depositing money and checks.

The operation of an ATM terminal is well known. Most, if not all, ATMs include a cash dispenser. The logic for controlling operation of the ATM is typically implemented as a specially programmed computer. The computer operates a user interface through which the cardholder interacts with, and selections functions offered through, the ATM. Network interfaces enable the ATM to communicate over one or more network connections. Special electronic circuits are typically used to encrypt and decrypt data. Encoded on cards are account information, such as cardholder name, bank identification numbers (BIN), account numbers, and additional information. However, it is anticipated that, in the future, cards might be supplanted, such as by smart cards (i.e., chip cards having embedded integrated circuits capable of securely saving certain cardholder data), and/or by enabling ATMs to read card information wirelessly or optically via a cardholder's phone or other device. References to “cardholder” are therefore intended to include customers of a financial institution who have access to services of an ATM by means other than a card. References to “card” and “card reader” herein are intended to include future alternatives unless otherwise noted.

For many years, a customer could only use ATMs operated by or on behalf of the card issuer. These ATMs would connect only to the bank's internal banking system. However, most ATMs are now connected to one or more ATM networks. These networks route transaction messages between the ATM and the issuer. These networks allow a cardholder, as long as the card issuer is a member of a network to which the ATM can connect, to use ATMs other than those operated by or for the issuer. However, unless an ATM used by the cardholder belongs to the issuer, or is operated by an entity with which the issuer has a special relationship, transaction fees will typically be charged to the cardholder for conducting a transaction through that ATM. The owner or operator of an ATM, who is called the “acquirer,” typically charges a fee or surcharge for cash withdrawals in such situations. The acquirer can be, for example, the financial institution providing the ATM, a merchant hosting the ATM, or any organization that owns the ATM or operates it on behalf of its owner. The surcharge is typically debited from the cardholder's account. In addition, the issuer can charge the cardholder an additional fee, sometimes called a “foreign fee,” for processing transactions that originate from an acquirer other than the issuer or an acquirer with whom the issuer has a special relationship. Such a transaction is called a “not-on-us” transaction, as opposed to an “on us” transaction, for which a cardholder is typically not charged a transaction fee.

### SUMMARY

The following disclosure relates generally to a computer implemented process and system for determining, based on one or more transactions at an ATM incurring a transaction fee, the location of one or more alternate ATMs within a predefined geographic vicinity of that ATM, which the card issuer prefers for the cardholder to use, or that the cardholder may prefer to use to reduce or to avoid transaction fees.

In one example, a computer implemented process determines, in response to a “not-on-us” transaction received by an issuer processor, geographic coordinates of the ATM that was used for the transaction from information contained in the transaction data that is sent from the ATM. With the geographic coordinates, it determines one or more alternate ATMs within a geographic proximity of the ATM that was used, based on predetermined parameters. The cardholder is notified or alerted of the alternate ATM in a message that identifies the location of one or more alternate ATMs. In one embodiment, the alternate ATMs are those with which the cardholder may transact with lower transaction charges or without incurring one or more transaction charges. In another embodiment, the message may also include one or more offers that encourage use of at least one of the alternate ATMs. For example, the offer might be a discount coupon for use in a store where the ATM is located, or for a product or service offered by that merchant, or for services at the card issuer or other financial institution; or it could be an offer to reimburse fees.

The process does not need to occur in real time. The alert messages can be, for example, printed on bank statements, generated on web pages served during an on-line banking session, sent by email or SMS, displayed on “smart phone” applications, or otherwise communicated to the cardholder.

In one exemplary implementation, a database mapping street addresses to geographical coordinates (longitude and latitude, for example) is maintained. Using address information for the acquirer ATM terminal contained in transaction data received from the acquiring ATM, geographic coordinates most closely corresponding to a street address to the acquiring ATM is determined from, for example, a database or service mapping the address to geographical coordinators. From a database maintaining the geographic locations of alternate ATM terminals, alternate ATM terminals that are geographically proximate are determined using predetermined parameters.

The foregoing methods and apparatus can determine when a cardholder has performed an ATM originated transaction that is subject to fees and alert or notify the cardholder about location(s) of one or more other ATM's that could have been used for free, and that are in the vicinity of the ATM that originated the transaction.

### BRIEF DESCRIPTION OF THE DRAWINGS

FIG. 1 is a flow diagram illustrating aspects of a flow in an exemplary alert process and apparatus.

FIG. 2 is flow diagram illustrating additional aspects of flow in the exemplary alert process and apparatus of FIG. 1.

FIG. 3 is yet another data flow diagram illustrating additional aspects of data flow in the exemplary alert process and apparatus of FIG. 1.

FIG. 4 is an example of a graphical representation of a cardholder web banking application user interface displaying an alert.

FIG. 5 is a flow diagram illustrating an alternative embodiment implemented using FTP file distribution.

FIG. 6 is a flow diagram illustrating another alternative embodiment implemented using SOA data distribution.

FIG. 7 is a flow diagram illustrating yet another alternative embodiment implemented using backend processing with cardholder data.

FIG. 8 is a flow diagram illustrating still another alternative embodiment implementing back end processing without cardholder data.

FIG. 9 is a flow diagram illustrating yet still another alternative embodiment implemented using hybrid back end data processing.

### DETAILED DESCRIPTION OF EXEMPLARY EMBODIMENTS

In the following description, like numbers refer to like elements.

For purposes of clarity, definitions are set forth below for several terms of art that appear in the following disclosure:

An “acquirer” is the financial institution or organization that operates a particular ATM and/or point of sale (POS). In the case of an ATM owned by a third party, the acquirer operates it on behalf of the owner.

“Acquirer processor” refers to a transaction processor, which is comprised of one or more specially programmed computers, that is capable of communicating with one or more ATM's connected to it, and that translates transaction data to and from the ATM into a format acceptable by financial transaction networks.

“Back end” refers to computer implemented interfaces and services removed from the client and/or user for the purpose of resource consolidation as well as security, for example in the case where several users need to share the same data source.

“Balance enquiry transaction” refers to a transaction at an ATM by which a cardholder may determine and display or print the current balance of a checking or savings account.

A “banking system” is a system comprised of one or more specially programmed computers responsible for hosting bank accounts, as well as authorizing any request to debit or credit any account. A banking system is typically connected to all sources from where transactions may be sourced, including an issuer processor in the case of ATM and POS transactions.

A “branded ATM” refers to an ATM that is owned by an independent ATM deployer or merchant, and that processes transactions initiated through the ATM on behalf of a financial institution.

A “foreign fee” generally refers to a fee typically charged by a card issuer when a cardholder initiates a transaction on an ATM that is not owned or operated by the issuer, or that is owned by a third party who is not affiliated with the issuer.

“Issuer” or “card issuer” refers to a financial institution that issues credit, debit, ATM or prepaid cards to cardholders. The issuer or an institution managing the cardholder account(s) typically performs authorization of a card transaction.

“Issuer processor” refers to a transaction processor that validates transaction requests originated from ATM's or POS devices. It translates transactions into and from the format compatible with the Banking System for the Card Issuer.

A “not-on-us transaction” is a transaction processed by an acquirer that is different from the card issuer. An example of such an acquirer is an independent ATM deployer.

An “on-us transaction” is one in which the acquirer and the card issuer are the same financial institution, or one in which the ATM is operated by a third party acquirer on behalf of the card issuer, such as a branded ATM.

A “PAN” is a primary account number displayed on the cardholders card, typically 16 to 19 digits in length.

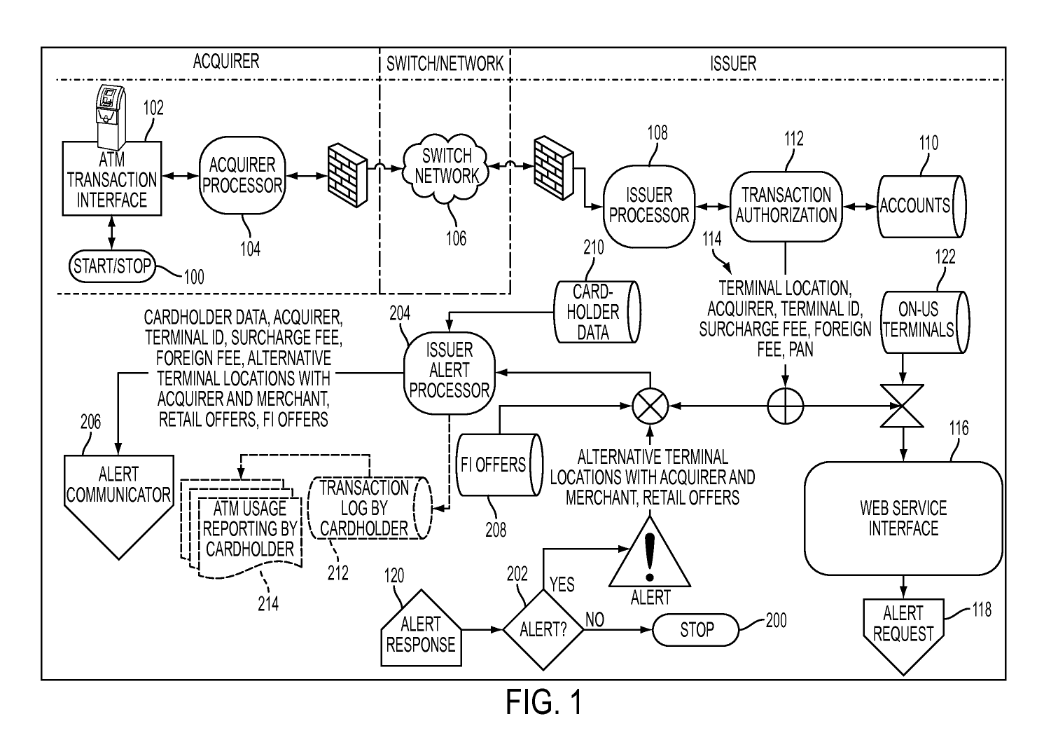

Referring to FIG. 1, a process carried out by the apparatus can begin at 100 when a cardholder utilizes an ATM transaction interface 102 of an acquirer processor 104. Possible transactions include withdrawals, balance enquiries, and transfers. Transaction requests and responses are routed via the acquirer processor 104 platform servicing the ATM that was used for the transaction. The acquirer processor 104 will typically charge the cardholder with a disclosed surcharge fee in the case where the ATM terminal used does not belong to or is not branded with their card issuer. Independent ATM deployers typically charge customers a surcharge fee, unless the cost for the transaction is covered by prior arrangement with the cardholders' financial institution.

Acquirer processor 104 can be interfaced via a switch network 106 with an issuer processor 108 hosted by the financial institution managing the cardholder's account. Accordingly, the transaction can be routed to the issuer processor 108 that accesses an accounts data store 110 to perform a transaction authorization 112. The financial institution's banking system is responsible for transaction authorization based on the cardholder's account detail. The banking system may charge the cardholder a foreign fee to cover the cost of acquiring the transaction via the financial network.

In accordance with the exemplary embodiment described herein, data 114 from the transaction authorization 112 can be employed by an alert processor to process alerts. This data can include ATM terminal location, which is typically street address, acquirer identity, ATM terminal identity, surcharge fee, foreign fee, bank account number, and primary account number (PAN). Portions of this data 114 can be supplied to a web service interface 116 of the alert processor, so that the alert web service interface 116 can generate an alert request 118 containing some or all of the data 114. Optionally, a search radius and/or maximum number of alternative ATM locations may be specified as well. Business rules stipulating conditions under which a transaction will be tagged for an “alert” can also be customized and presented with the above data. For example, financial institutions may choose to trigger alerts when either or both of the surcharge fee and foreign fee are present, or they may decide to trigger on a surcharge fee only. Giving card issuers this flexibility permits the card issuers to determine, for example, whether to request an alert in the event that the acquirer is in a surcharge-free network, resulting in a foreign fee, although no surcharge fee was applied. In the event that the card issuer wishes to trigger an alert request for such transactions, the issuer can still specify business rules to indicate that the alert should not trigger. This capability provides issuers options for logging transactions and tracking trends as further explained below, without limiting issuers' options regarding when to issue an alert to cardholders.

In an exemplary embodiment, all of the above data except the PAN and bank account number, can be presented to the alert web service interface 116. The PAN and bank account number can then be used once an alert response 120 is received back from the web service to identify the cardholder to whom the notification needs to be sent. This feature allows for the alert processor to perform the request with anonymous data. The alert processor can also access an on-us terminals data store 122 to determine if a transaction is an “on-us” transaction, and thereby selectively process only “not-on-us” transactions for alerts.

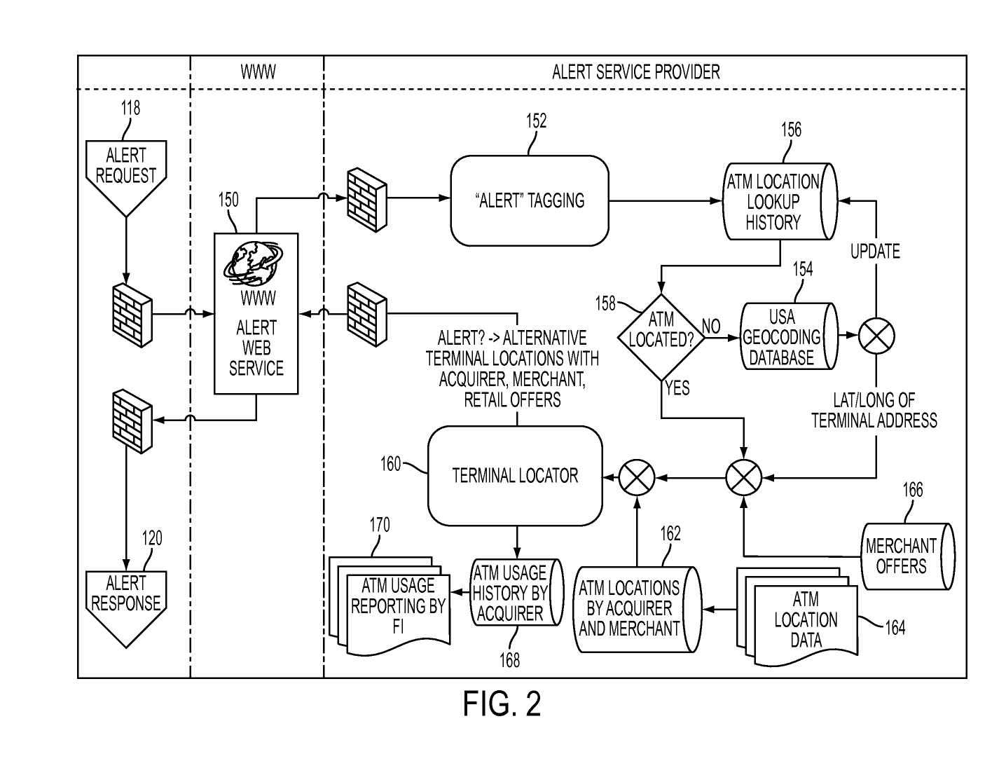

Turning now to FIG. 2, the alert request 118 can be received by an alert back end processor hosting an alert web service 150. The alert web service 150 can act as a communication endpoint accessible through the Internet. This architecture can allow for a single back end processor to provide service to multiple remote clients hosted by various card issuers. In some embodiments, the alert processor can perform an alert tagging process 152 by tagging a particular transaction as an “alert” transaction. An “alert” transaction can be identified when the cardholder has been subjected to fees identified in the business rules as described above.

The alert processor can access a geo-coding data store 154 having recorded therein latitude and longitude coordinates of street addresses. The street address of the terminal can be used to determine the latitude and longitude coordinates of the terminal location. To enhance the performance of this look-up process, an ATM location look-up history data store 156 can be maintained to record locations that were previously accessed. The alert processor can look first in this data store 156, and access the geo-coding data store 154 if a determination is made at decision step 158 that the terminal location cannot be found in the data store 156. Data store 156 can be updated whenever data store 154 is accessed.

The alert processor can next perform a terminal locator process 160 in which the terminal location coordinates are compared to those of a complete list of candidate alternative terminal locations recorded in ATM locations data store 162. This regularly updated data store 162 can contain a current list of all candidate terminals and their location data 164 as latitude and longitude, as well as street addresses. This list can include terminals participating in a surcharge-free or reduced fee—i.e. terminals for which a lower or no foreign fee and/or a lower or no surcharge fee would be incurred—network as well as those terminals of each card issuer participating in an alert program. Surcharge-free or reduced fee network ATMs can always be in scope as candidate terminals, while the card issuer terminals can be limited to only transactions belonging to that card issuer. In some embodiments, the terminal locator process can observe the constraints specified by card issuers by limiting the results of the search of data store 162 to only the alternative ATM locations within a specified search radius, or the terminals closest to the original location limited by a specified maximum number. The result of this search can then be added to the result as the “alternative terminal locations”.

With the alternative ATM locations identified, the terminal locations process can consult a merchant offers data store 166 to find all merchant offers associated with each of the alternative terminal locations. This data store 166 can contain all current merchant offers extended by merchants hosting ATMs. The terminal locator process 160 can then generate the alert response 120 for those transactions tagged with “alert” by appending the alternative terminal addresses as well as the acquirer and merchant (if applicable). Any terminals with merchant offers can also include those offers. For example, an alternative location for an ATM terminal located in a convenience store can be paired with an electronic coupon for redemption at that retail location. In additional or alternative embodiments, an alternative location for a POS terminal having a cash back option and located at a pharmacy counter can be paired with an electronic coupon for redemption at that retail location.

In some embodiments, the terminal locator process can maintain an ATM usage history data store 168 that logs all transactions processed. This data store 168 can allow for reports 170 to each issuer showing trends in monthly transaction volumes on “alert” transactions vs. surcharge-free transactions. Accordingly, it should be understood that issuers who choose to generate an alert request in the event of a foreign fee and absence of a surcharge fee (e.g., surcharge-free network terminal), yet specify business rules that flag transactions as alerts only in the presence of a surcharge fee, can track trends while generating alerts to cardholders only in the case of a surcharge fee.

Returning now to FIG. 1, the alert response received by the issuer can be ignored at 200 if it is determined at 202 that the transaction is not tagged as an alert. However, in the event of an alert, an issuer alert processor 204 can generate an alert communicator message 206 by adding additional information to that contained in the alert response 120. For example, the issuer alert processor can access a financial institution offers data store 208 to obtain offers such as future fee rebates for using a financial institution ATM rather than an ATM charging fees. Such offers can then be added to the alert communicator message 206, and the PAN appended to identify the cardholder. The PAN can be used by the issuer to retrieve customer data from cardholder data store 210, such as account number, email address, telephone number, etc. Accordingly, the alert communicator message 206 can contain cardholder data, acquirer terminal ID, surcharge fee, foreign fee, alternative terminal locations with acquirer and merchant, retail offers, and financial institution offers.

In some embodiments, the issuer alert processor can maintain a transaction log data store 212. For example, all ATM transactions (tagged as “alert” or not) may be logged by cardholder. This data store 212 can allow for reports 214, such as fee history and ATM usage patterns of each cardholder.

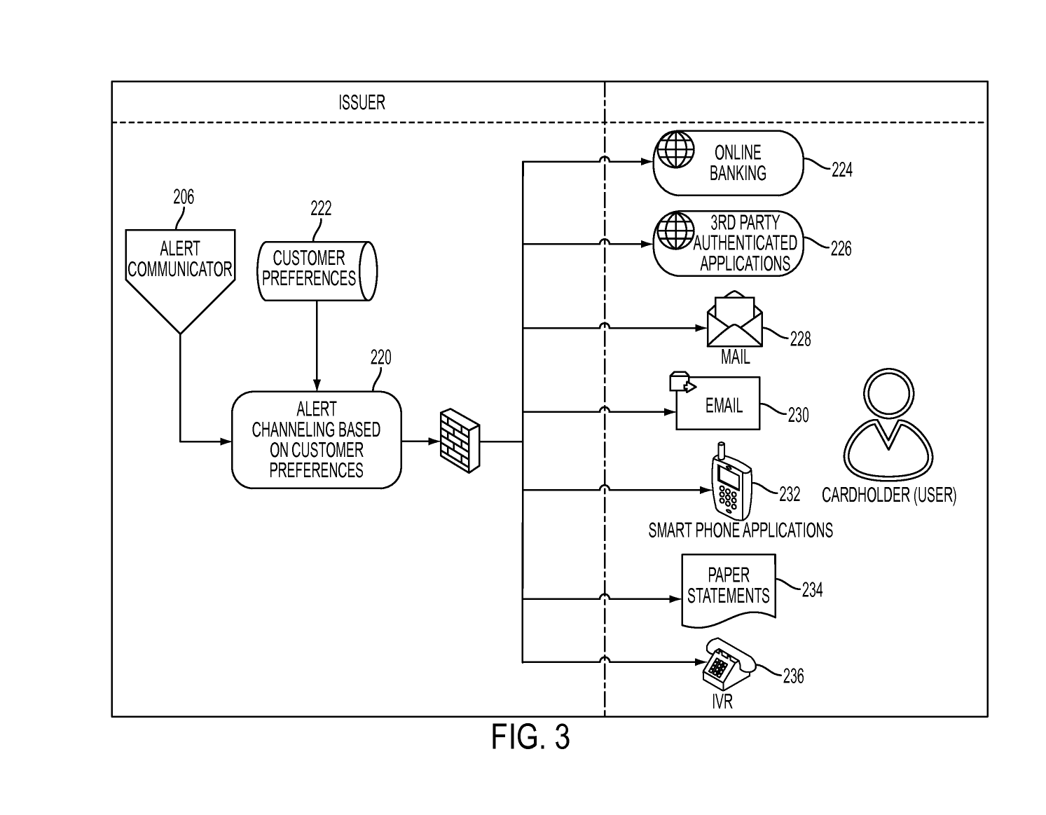

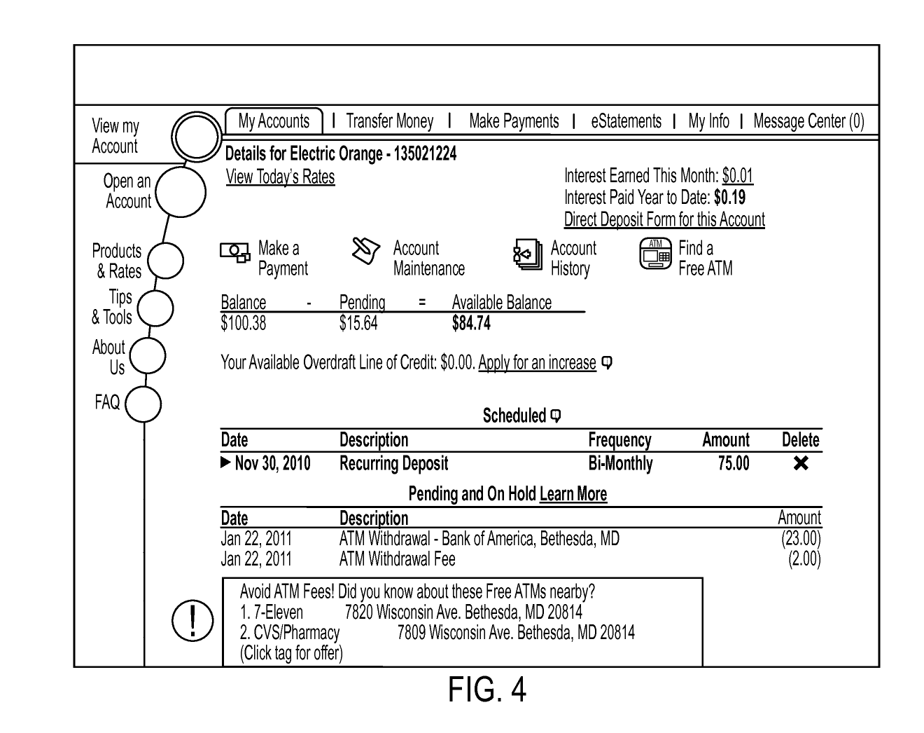

Turning now to FIG. 3, the alert communicator message 206 can be handled by an alert communicator process 220 that can perform alert channeling based on customer preferences recorded in data store 222. It is envisioned that the alert channeling can communicate alerts to cardholders in a variety of ways, some of which can be pending certain cardholder preferences. For example, an online banking application 224 (see also FIG. 4) can permit a customer's online transaction information to be expanded to indicate alternative surcharge-free ATM locations compared to the location of the transaction on the statement subjected to fees. It is envisioned that historical summaries of fees paid or avoided can also be viewed by the cardholder in the online banking application. It is additionally envisioned that alert data can be fed to registered third party applications 226. Further mechanisms by which the cardholder can receive alerts and offers are mail 228, email 230, smart phone applications 232, or SMS (i.e., text message). Also, paper statements sent to customers can be expanded with alert data, and alerts can be queued and communicated via interactive voice response (IVR) when cardholders call and interact with the issuer's automated phone system.

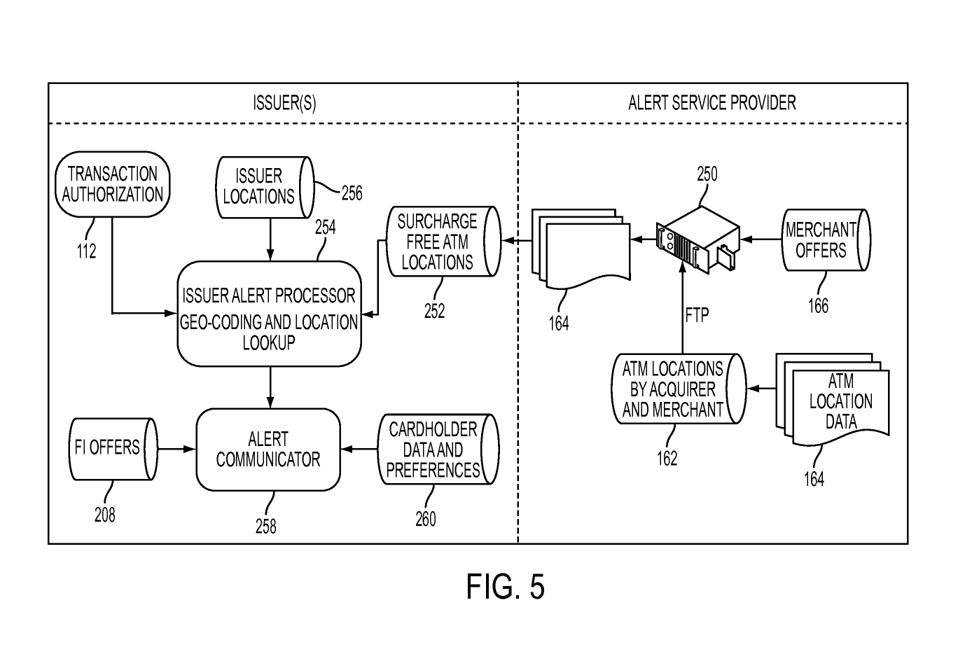

Turning now to FIG. 5, an alternative embodiment can implement file FTP distribution. In this embodiment, a back end processor 250 can make ATM location data 164 (i.e., of ATM locations data store 162) and merchant offers (i.e., of merchant offers data store 166) available to each issuer participant by performing daily file distribution. In this case, all logic related to the alert identification, location look-up, and notification can be handled on the issuer side. For example, the ATM location data 164 and merchant offers can be stored in surcharge-free ATM locations data stores 252 maintained at each issuer. An issuer alert processor 254 can receive output from transaction authorization process 112, and respond to a transaction authorization by accessing data store 252 and an issuer locations data store 256 and performing geo-coding and location look-up. The issuer's alert communicator process 258 can add financial institution offers from data store 258 and perform the alert channeling based on cardholder preferences in cardholder data and preferences data store 260. While this embodiment benefits from a simple back end implementation, it suffers from high bandwidth usage, since multiple issuers can each require daily updates of all location and offer data. Also, all alert processing, geo-coding, and look-up logic have to be implemented and maintained at all issuer locations.

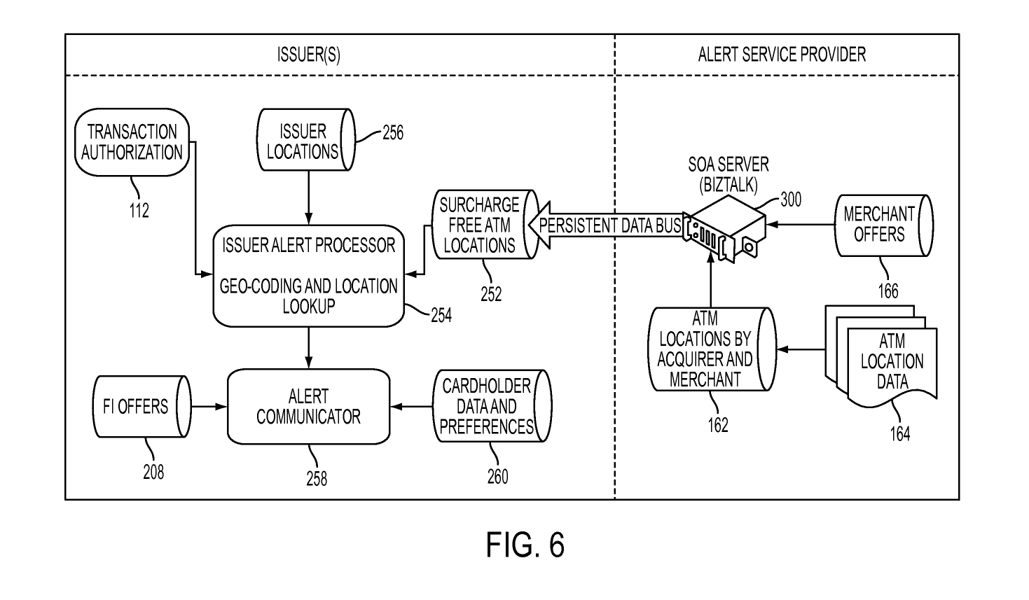

Turning now to FIG. 6, another alternative embodiment can implement Service Oriented Architecture (SOA) data distribution. In this embodiment, a back end processor 300 can make ATM location data 164 (i.e., of ATM locations data store 162) and merchant offers (i.e., of merchant offers data store 166) available to each issuer participant by employing a persistent SOA data bus. In this case, all logic related to the alert identification, location look-up, and notification can be handled on the issuer side. For example, the ATM location data 164 and merchant offers can be stored in surcharge-free ATM network locations data stores 252 maintained at each issuer. An issuer alert processor 254 can receive output from transaction authorization process 112, and respond to a transaction authorization by accessing data store 252 and an issuer locations data store 256 and performing geo-coding and location look-up. The issuer's alert communicator process 258 can add financial institution offers from data store 258 and perform the alert channeling based on cardholder preferences in cardholder data and preferences data store 260. In this embodiment, the persistent SOA data bus can be used for communication, and updates can be performed by back end processor 300 either at need or on a periodic basis for only those items that have changes. This embodiment can therefore allow for more sophisticated data interfaces, resulting in less bandwidth and improved reliability. However, this embodiment suffers from the requirement that all alert processing, geo-coding, and look-up logic have to be implemented and maintained at all issuer locations.

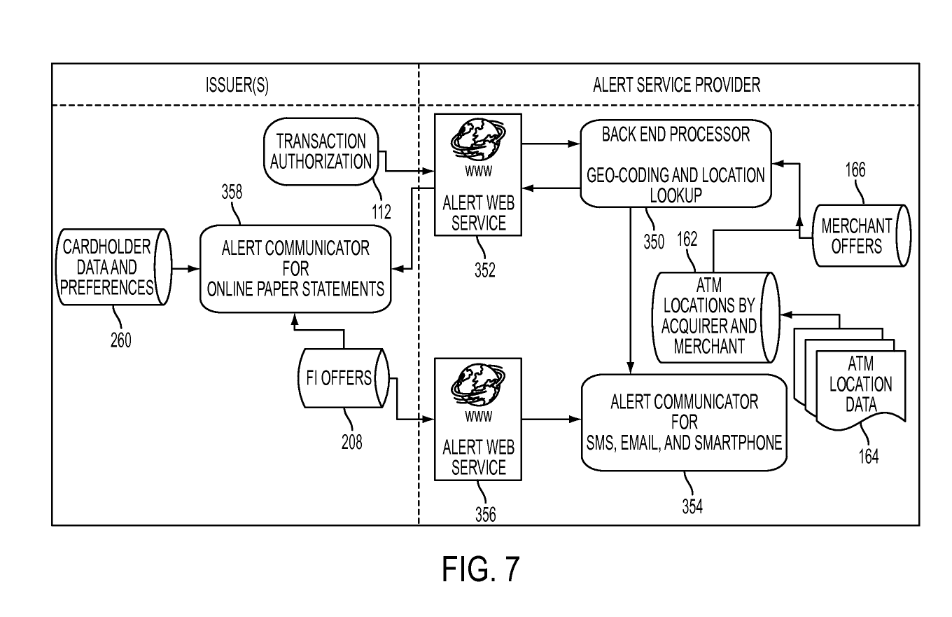

Turning now to FIG. 7, yet another alternative embodiment can implement back end processing with cardholder data. In this case, the issuer can send data elements to a centralized back end processor 350 via an alert web service 352 responsive to a transaction authorization process 112. These data elements can include the PAN and various cardholder data, such as cardholder name, cardholder preferences, cardholder address, cardholder telephone numbers, and cardholder email contact information. The back end processor 350 can perform the geo-coding and location look-up using merchant offers data store 166, ATM locations data store 162, and ATM location data 164, and can then send the alerts directly to the cardholder by an alert communicator process 354 that handles alert delivery SMS, email, and smart phone applications. Another alert web service 356 can permit the alert communicator process 354 to access financial institution offers data stores 208 of issuers for this purpose. In this embodiment, it is envisioned that some alerts, such as those communicated by online web notifications and paper statements, can still be handled by an alert communicator 358 of the issuer accessing data store 260. This embodiment benefits from economy of scale due to performing and maintaining all of the processing at one location. An additional benefit of this embodiment is accessibility of all transaction history logs at a single location. However, this embodiment requires that issuers be willing to share customer data.

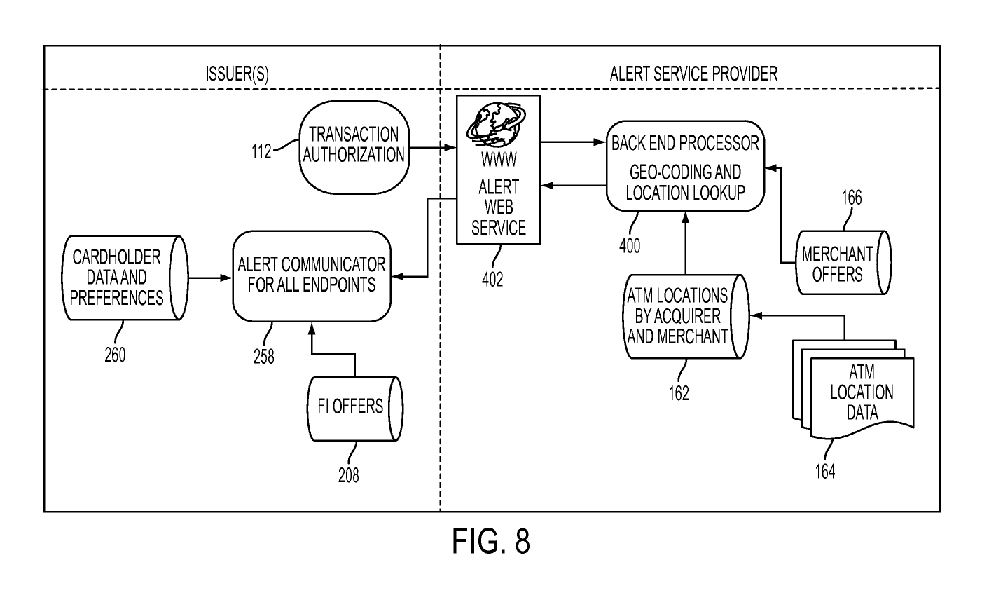

Turning now to FIG. 8, still another alternative embodiment can implement back end processing without cardholder data. In this embodiment, issuers can avoid forwarding cardholder data to the back end processor 400 via an alert web service 402 responsive to a transaction authorization process 112. The back end processor 400 can perform the geo-coding and location look-up using merchant offers data store 166, ATM locations data store 162, and ATM location data 164. The alert web service 402 can provide the alert response to the financial institution's alert communicator 258 to add financial institution offers from data store 208 and deliver the alerts according to the cardholder preferences of data store 260. In other words, the back end processor 400 can then perform location look-up, while the issuer can communicate all alerts to the cardholders from their own domains. Standard software modules can be provided to issuers who do not wish to share customer data and thus permit the issuers to communicate the alerts. This embodiment benefits from economy of scale due to performing and maintaining all of the processing at one location. An additional benefit of this embodiment is accessibility of all transaction history logs at a single location. However, issuer implementation is more involved due to integration of the alert notification functionality.

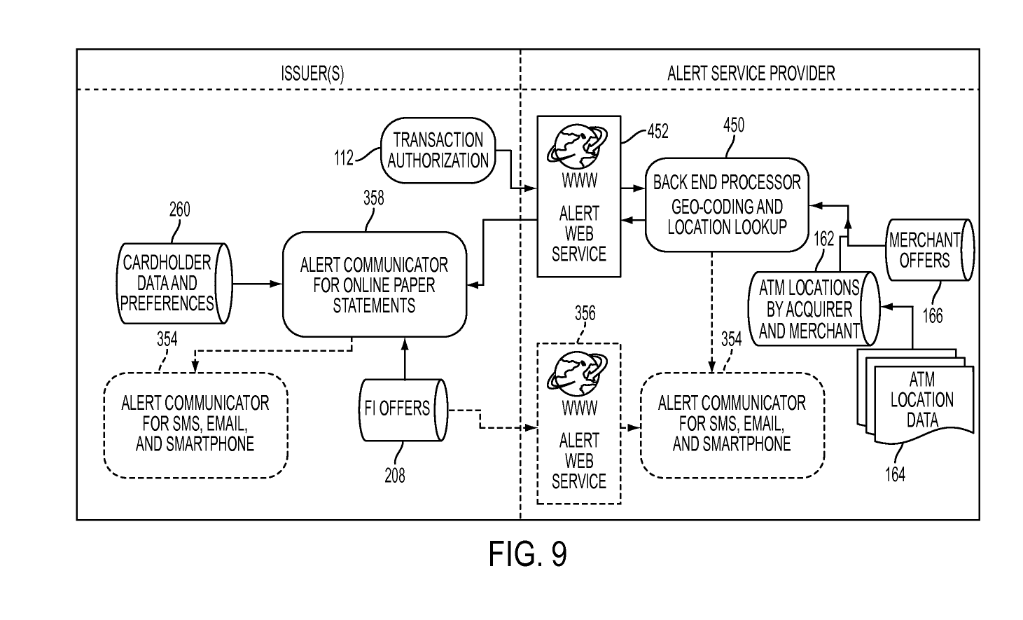

Turning now to FIG. 9, yet still another alternative embodiment can implement hybrid back end data processing. This embodiment basically combines the aspects of the embodiments of FIG. 7 and FIG. 8 by allowing issuers the option of sharing cardholder data or implementing the standard modules to carry out the alert notification.

In this case, the issuer can choose whether to send data elements to the centralized back end processor 450 via an alert web service 452 responsive to a transaction authorization process 112. These data elements can include the PAN, bank account number and various cardholder data, such as cardholder name, cardholder preferences, cardholder address, cardholder telephone numbers, and cardholder email contact information. Regardless of whether the data elements were provided by an issuer, the back end processor 450 can perform the geo-coding and location look-up using merchant offers data store 166, ATM locations data store 162, and ATM location data 164. If the issuer chose to provide the data elements, then the back end processor 450 can then send the alerts directly to the cardholder by the alert communicator process 354 that handles alert delivery via SMS, email, and/or smart phone applications. The other alert web service 356 can permit the alert communicator process 354 to access financial institution offers data stores 208 of issuers for this purpose. Even for issuers who chose to provide the data elements, it is envisioned that some alerts, such as those communicated by online web notifications and paper statements, can still be handled by an alert communicator 358 of the issuer accessing data store 260. However, if the issuer chose not to provide the data elements, then the back end processor 450 can simply deliver the alert response to the issuer via alert web service 452, and the issuer can deliver the alert to the cardholder using standard modules that provide the alert communicator 358 and the alert communicator 354 at the issuer location. This embodiment benefits from economy of scale due to performing and maintaining all of the processing at one location. An additional benefit of this embodiment is accessibility of all transaction history logs at a single location. However, offering the additional options to issuers results in a more complex implementation.

The foregoing description is of exemplary and preferred embodiments employing at least in part certain teachings of the invention. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated structures or the disclosed embodiments.

What is claimed is:

1. An apparatus for generating an alert for a cardholder who utilizes an automated teller machine (ATM) terminal, for which a transaction fee is charged, the apparatus comprising:
a geo-coding data store having recorded therein geographic coordinates corresponding to street addresses;
a terminal locations data store having recorded therein locations of alternate ATM terminals, for which the cardholder would be charged a reduced transaction fee, as compared to the transaction fee that was charged, or no transaction fee;
at least one computer processor interfaced with said geo-coding data store and said terminal locations data store, wherein said at least one computer processor is operatively connected to employ said geo-coding database to determine geographic coordinates for an acquiring ATM terminal used by the cardholder to conduct a transaction, for which a transaction fee is incurred, corresponding to a street address obtained as part of transaction data received from the acquiring ATM terminal in connection with the transaction, employ said terminal locations data store to search for, using one or more predetermined search parameters, at least one of the alternate ATM terminals, having geographic coordinates within a predetermined geographic proximity to those of the fee-based ATM terminal, and generate alert information including a street address of the at least one of the alternate ATM terminals.

2. The apparatus of claim 1, wherein said at least one computer processor is operatively connected to receive from a card issuer of the cardholder an alert request specifying the street address of the acquiring ATM terminal, and generate an alert response to the issuer containing the alert information.

3. The apparatus of claim 2, wherein the alert request further species an identity of an acquirer, an identity of the acquiring ATM terminal, a surcharge fee, a foreign fee, a number of desired search results, and a search radius.

4. The apparatus of claim 3, wherein the alert request further specifies at least one business rule for tagging transactions dependent on presence of at least one of the surcharge fee or the foreign fee, and said at least one computer processor is operatively connected to tag transactions according to the business rules.

5. The apparatus of claim 1, wherein the alert information includes two or more of the alternate ATM terminals nearest to the acquiring ATM.

6. The apparatus of claim 1, wherein said at least one computer processor is operatively connected to generate the alert information at least in part by constraining search of said terminal locations data store by at least one of radius or number of terminals.

7. The apparatus of claim 1, wherein said at least one computer processor is operatively connected to maintain an ATM location look-up history data store.

8. The apparatus of claim 1, wherein said at least one computer processor is operatively connected to maintain an ATM usage history data store.

9. The apparatus of claim 1, further comprising:
a merchant offers data store recording one or more current merchant offers extended by one or more merchants hosting one or more on-us ATM terminals.

10. The apparatus of claim 9, wherein said at least one computer processor is operatively connected to employ said merchant offers data store to add a merchant offer to the alert information, wherein the merchant offer pertains to at least one of goods or services available to a cardholder at a merchant location at which the non fee-based terminal is located.

11. The apparatus of claim 1, further comprising:
a financial institution offers data store recording one or more current financial institution offers extended by one or more financial institutions providing one or more of the alternate ATM terminals.

12. The apparatus of claim 11, wherein said at least one computer processor is operatively connected and programmed to employ said financial institution offers data store to add a financial institution offer to the alert information, wherein the financial institution offer pertains to future rebates of ATM transaction fees.

13. The apparatus of claim 1, wherein said at least one computer processor is operatively connected to perform delivery of an alert containing the alert information to a cardholder, including delivery of the alert via one of more of the following:
(a) online banking application;
(b) third party authenticated application;
(c) mail;
(d) email;
(e) smart phone application;
(f) text message; or
(g) interactive voice response.

14. The apparatus of claim 13, further comprising:
a cardholder delivery preferences data store, wherein said at least one computer processor is operatively connected to employ said cardholder alert delivery preferences data store to perform delivery of the alert to the cardholder as specified by one or more preferences of the cardholder recorded therein.

15. The apparatus of claim 13, wherein said online banking application operatively displays summaries of fees at least one of paid or avoided.

16. A method of generating alerts for cardholders who conduct a transaction at an automated teller machine (ATM) terminal, for which at least one transaction fee was incurred, the method comprising:
accessing with a specially programmed computer a geo-coding data store having recorded therein geographic coordinates corresponding to street addresses, and employing said geo-coding database to determine geographic coordinates for an acquiring ATM terminal used by the cardholder to conduct a transaction, for which a transaction fee is incurred, that correspond to a street address obtained as part of transaction data received from the acquiring ATM terminal in connection with the transaction;
accessing a terminal location's data store having recorded therein location information for alternate ATM terminals for which the cardholder would be charged a lower transaction fee or would not be charged the at least one transaction fee, and employing said locations data store to obtain a street address of at least one of the alternate ATM terminals having geographic coordinates within a predetermined geographic vicinity of the acquiring ATM terminal; and
generating alert information including the street address of the at least one on-us terminal.

17. The method of claim 16, further comprising:
receiving from an issuer an alert request specifying the street address of the acquiring ATM terminal; and
generating an alert response to the issuer containing the alert information.

18. The method of claim 17, wherein the alert request further species an identity of an acquirer, an identity of the acquiring ATM terminal, a surcharge fee, a foreign fee, a number of desired search results, and a search radius.

19. The method of claim 17, wherein the alert request specifies at least one business rule for tagging transactions as fee-based dependent on presence in the alert request of at least one of a surcharge fee or a foreign fee, the method further comprising:
tagging transactions according to the business rules.

20. The method of claim 16, wherein the alert information includes two or more of the alternate ATM terminals nearest to the acquiring ATM terminal.

21. The method of claim 16, further comprising:
generating the alert information at least in part by constraining a search of said terminal locations data store by at least one of radius or number of terminals.

22. The method of claim 16, further comprising:
maintaining an ATM location look-up history data store.

23. The method of claim 16, further comprising:
maintaining an ATM usage history data store.

24. The method of claim 16, further comprising:
accessing a merchant offers data store recording one or more current merchant offers extended by one or more merchants hosting one or more of the alternate ATM terminals.

25. The method of claim 24, further comprising:
employing said merchant offers data store to add a merchant offer to the alert information, wherein the merchant offer pertains to at least one of goods or services available to a cardholder at a merchant location at which at least one of the alternate ATM terminals is located.

26. The method of claim 16, further comprising:
accessing a financial institution offers data store recording one or more current financial institution offers extended by one or more financial institutions providing one or more of the alternate ATM terminals.

27. The method of claim 26, further comprising:
employing said financial institution offers data store to add a financial institution offer to the alert information, wherein the financial institution offer pertains to future rebates of ATM transaction fees.

28. The method of claim 16, further comprising:
performing delivery of an alert containing the alert information to a cardholder, including delivery of the alert via one of more of the following:
(a) online banking application;
(b) third party authenticated application;
(c) mail;
(d) email;
(e) smart phone application;
(f) text message; or
(g) interactive voice response.

29. The method of claim 28, further comprising:
accessing a cardholder delivery preferences data store; and
employing said cardholder alert delivery preferences data store to perform delivery of the alert to the cardholder as specified by one or more preferences of the cardholder recorded therein.

30. The apparatus of claim 28, further comprising:
displaying summaries of fees at least one of paid or avoided via the online banking application.
